(19) United States
(12) Patent Application Publication
(10) Pub. No.: US 2010/0279649 A1
(43) Pub. Date: Nov. 4, 2010

(54) Personal Security and Law Enforcement Evidence Documenting and Criminal Apprehension Coordinated Improved System

(76) Inventor: Michael Robert Thomas, North Fort Myers, FL (US)

Correspondence Address: MICHAEL R. THOMAS INVENTING CONSULANT, 189 Evergreen Rd., NORTH FORT MYERS, FL, 33903, US

(21) Appl. No.: 12/604,636

(22) Filed: Oct. 23, 2009

Related U.S. Application Data
(60) Provisional application No. 61/107,802, filed on Oct. 23, 2008.

(51) Int. Cl. H04W 4/22

(52) U.S. Cl. 455/404.2

(57) ABSTRACT

This Invention contains a System of Components for Improvement in Citizens, Law Enforcement Personnel Protection, and Property, Security and Overall Crime Reduction through Criminal Apprehension Success Rates. A Remote Sheriff Controlled Video Remote Controlled Law Enforcement Response and Video Evidence Documenting Improvements including Deputy Audio/Video Camera Forehead Mounted and Selective Force Weapons Mounted on Miniature Drone Aircraft and Helicopters for Low Speed Surveillance or High Speed Chase, also used for Business or Police Station Roof Top Mounted Decoy and Live Drone Hangers or Telescoping Equipment for Squad Car and Private Security. Also Permanent Public Roadway Mounted Equipment including Stop Stick deployment control also Home or Business Security System Instant Interconnected and 911 System Audio/Video Emergency Caller Instant Interconnected with Improved Cell Phone Telephoto Lens Capable and Instant 911 Interconnection with Family Members Cell Phone Location Finder and Home Security Camera Concealment Equipment and Marine Cellular Mapping Devices.

### DRAWING DESCRIPTIONS AND SPECIFICATIONS NUMBERED

FIG. 1 Multiple Cellular Phone and GPS Cellular Tower Locator and Camera System

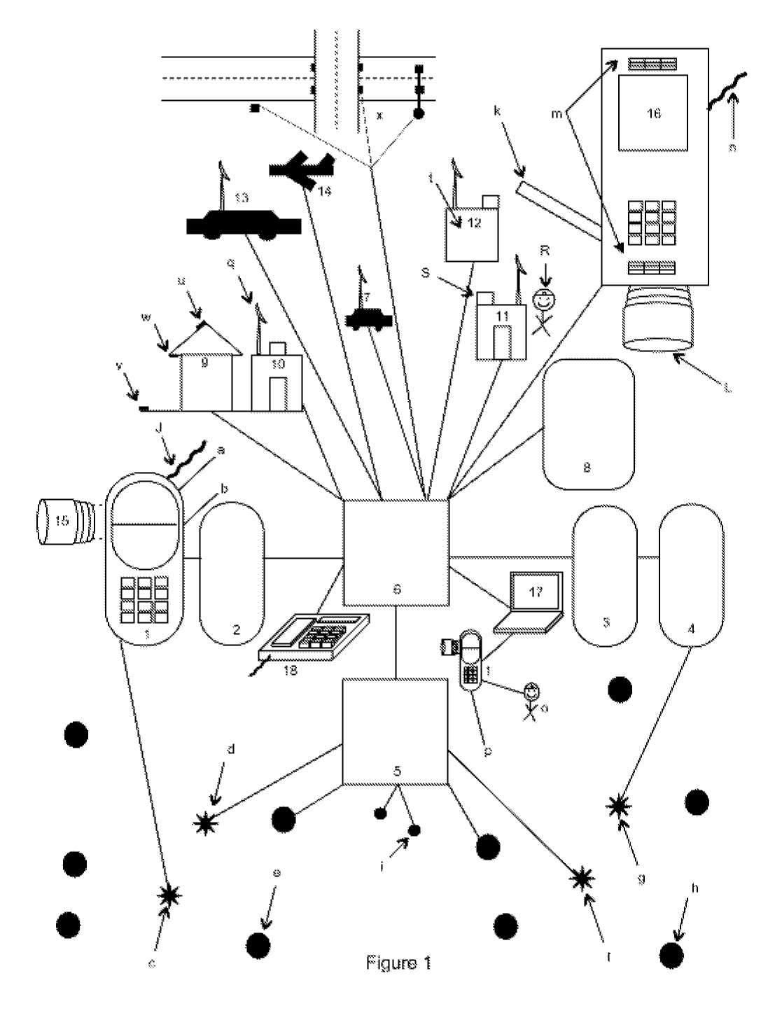

1. Cell Phone with Emergency Beeper or Custom Tone Alert Owner verification can be achieved by entering a PIN+SS+DL numbers as identifiers. Optional Existing Computer Functions and all other Currently Available Cellular Options Multiple Location Identification of Cell Phones Feature through Coordination with GPS and/or Cellular Tower Locators

2. Two Cell Minimum for Communication (Spousal)

3. Cell Phones Additional (Sibling 1) or Business Associates

4. Cell Phones Additional (Sibling 2) and (4 to 4,000+ for Military Operations)

5. Communications Center (GPS and Cellular Tower)

6. Monitoring and Cellular Telephone Company Communication Center

7. Civilian or Private Security Patrol Permanently Installed Automotive GPS Systems and Telescopic Remote Controlled Video Cam

8. Hand Held GPS Map and Marine Mounted Locator Systems with Verbal Wireless Cellular Communication

9. Monitored Remote Controlled Hidden Telescoping Tower Camera Burglar Alarm System (Residential or Commercial) also Tower/Camera System on Battery Backup for Photographing Breaking and Entering Persons coming and going from the Crime Scene. Police Sting Operations create Bait Houses for B&E Suspects which would be similar to Bait Cars currently in use. Garage Doors can be left open to attract criminals or 3-4 delivered newspapers in the driveway. Valuable items such as big screen televisions visible in windows.

10. Commercial Business Location Burglar Alarm System

11. Police Station with Remote Controlled High Speed Drone Aircraft (120 mph and 140-220 lb.) or Miniature Low Speed Gasoline Battery Powered Drone Aircraft or Helicopter (25-60 mph and 15-40 lb.)

12. Bank, Jewelry Store, Pawn Shop, etc., High Crime Potential Business with Roof Top Mounted Miniature Airplane Hanger for Criminal Apprehension and Deterrent through a City Wide Miniature Aircraft Network. Only 10-20% of the hangers will contain live aircraft. The aircraft will be rotated among the hangers in early mornings in order deter crime through criminal lack of knowledge of locations of the real aircraft. Each miniature aircraft hanger will have an anti-theft security system. Also the system should be available for situations such as Commercial Businesses and Police Stations

13. Police or Private Detective Car with Drone Miniature Airplane or Helicopter with Gas Engine and Battery Backup for Silent Operation during Close Surveillance with Rooftop Mounted Launcher

14. Miniature Remote Controlled Chase Aircraft with High Power Lens and Infrared Night Vision Capable Camera with Wireless Transmission of Sound and Video Communication

15. Telephoto Lens (4× Digital Zoom) Existing camera phones can produce with or without this telephoto feature.

16. Large Cell Phone with Camera (Screen View or Side View) with Emergency Beeper or Custom Tone Alert Owner verification can be achieved by entering a PIN+SS+DL numbers as identifiers.

17. Computer with Multiple USB 2.0 or Higher Connections (Cell Phone Interconnection)

18. Telephone with USB 2.0 or Higher Connectivity and Visual Screen for Teleconferencing interconnected with Cellular Telephone, Standard Telephone, or Internet Audio/Video Conferencing with Simplified Push Buttons for Connections

a. Screen Display Shows Camera Cell Phone Image, Hand Held Device, Home Security, Business Security, and Multiple Security Warning Devices for such items as Equipment Items in Residential or Commercial Yard Storage, Law Library Text in Cell Phone or available through a connection with an internet search engine.

b. GPS Map Display with Location Specified of Additional Cell Phone Receivers 2 through 4

c. Cell Phone Location in GPS Satellite Field

d. Second Cell Phone in GPS or Cellular Tower Field

e. GPS Satellite Field

f. Second Cell Phone in GPS or Cellular Tower Field

g. Cell Phone Location in a Cellular Tower Field

h. Cellular Tower Field

i. Miscellaneous Cell Phone or Other Receiver Security Warning Devices (Burglar or Vandal) Motion Sensor or Voice Activated

j. USB Cord Connection for Telephone to Internet through Computer or Direct

k. Side View Screen for Video Cam

l. Zoom Lens 10×+

m. Audio and Voice Receiver for Cell Phone with Volume Control for Both

n. USB Cord Connection for Telephone to Internet through Computer or Direct

o. Jewelry Accessory, Key Chain, Wallet, or Purse, containing GPS Locator Chip corresponding Map Pin-Point Locations and Distances from the Located Cell Phones displayed on Owner's Cell Phone and the Owner's Immediate Network Cell Phones

p. Three Way Switching on Telephone (Land Line, Cellular, Internet)

q. Camera Tower, Fixed or Telescopic (50 to 400 ft.), Typical for Home, Commercial Business, or High Risk Business, used in conjunction with detail numbers 7, 9, 10, 11, and 12.

r. Police or Fireman outfitted with Forehead Mounted Camera to act a witness of the activities that are occurring in from of his or her eyes (Audio, Video, Remote Central Station Monitored and Recorded)

s. Miniature Remote Controlled Chase Aircraft Hanger

t. Miniature Flutter Copter similar to those in use in England

u. Telescoping Concealed Camera/Video/Audio with or without Night Vision, Mounted in Existing Wall or Specially Constructed Chase for Security Observation of Undesirable Activity

v. Underground Mounted Telescoping Concealed Camera/Video/Audio with or without Night Vision, Mounted in Existing Wall or Specially Constructed Chase for Security Observation of Undesirable Activity

w. Concealed Trap Door Opening or Smoked Bubble with Shooting Hole Mounted Crime Defense Individual or Multiple Stations interconnected with Police and/or Owner Remote Controlled Video/Audio Camera with Suspect Communication and Two Way Speakers televised/recorded armed with Paint Ball, Bean Bag, Tear Gas, Taser, Stop Strips, or 9 mm/45 Cal. Gun or any combination. The system can include private security and business owner monitoring switchable to law enforcement controlled and transcribed for the use of lethal and non-lethal weapons. These weapons included in these crime defense stations can be mounted and concealed on the underside of buildings, houses, lawn locations, security gate locations, stop lights, bridges, or freeway overpass. These systems can be real or decoy installations (10-20% live installation minimal crime deterrent potential).

x. Concealed street security crime deterrent and apprehension including audio/video smoked bubble coordinated weapons and police stop stick. These systems can be decoy or real installations (10-20% live installation minimal crime deterrent potential).

What is claimed is:

1. Claimed is the invention of an improved interconnected civilian, law enforcement, military, and social and civilian security, communications and emergency response, system including components for live audio/video communications, personal security, and crime intervention and apprehension with electronic and mechanical equipment used in conjunction with hand held and permanently mounted devices located in cars, drones, airplanes, businesses, residences, police stations, military installations, and roadways. The system is comprised of the following;
(a) A cell phone GPS road map or marine map overlay visual display showing the location or locations of a specific cell phone receiver or receivers through an interconnection with the Global Positioning Satellite System and/or a cellular tower positioning system together with the cell phone's normal functions of sound, video, and any other available features in an emergency or other situations the phone will allow both visual camera display and sound to be switched on by another phone the participating immediate system. One feature will be an emergency transmission continuation “No Shutoff” without a four digit shutoff code being entered in the event that the person holding the receiver pushes this button. This function will help to assist in determining last know location the holder of phone gets separated from the phone.
(b) A system that interconnects all different types of security transmission methods for fast track coordinated responses. A relay setup between the local phone company and the company's towers and the cell phone receivers themselves, monitored or unmonitored as necessary will allow the transmission of the coordinates of two or more cell phones.
(c) The combination of the existing systems which enable police and rescue to locate cell phone locations in case of missing persons and auto accident locations. This system will be an improvement on the existing system through the combination of those systems into an interconnected network.
(d) The use of this personal cell phone locator system in conjunction with hand held GPS systems and permanently installed automotive, marine, and portable theft deterrent, GPS systems.
(e) Complete emergency and security communication system interconnecting and standardizing a variety of existing systems into one communication network. The owner's cell phone controls the notification of police, fire, and rescue necessity, in the absence of direct notification by police, alarm system companies, and cell phone monitors. The system combines cellular tower and GPS methods of cellular phone and GPS monitored theft sensors with the additional information of voice and photo evidence enhancement. The new system will allow the police to automatically receive full photographic and verbal evidence and crime scene information both from the cell phone caller and the actual location on a map of the area and an expanded reference map. The use of the system coordinates home, personal and business alarm systems with marine and equipment sensors, and individual cell phone holder locations, to improve crime deterrent methods and improve communicating abilities. Photographically and verbally recorded messages may also be combined with verifiable time and location in order to provide evidence of an individual's activities for specific necessary evidencing (witness). The system allows parents to locate children that may be in distress and has the capacity to immediately relay any photograph and voice communications received to police and fire and other cell phone receivers for quicker and coordinated responses to undesirable situations
(f) Centralized cellular telephone communication, cameras, voice, cellular GPS, centralized company having an advantage of servicing all methods of security communication and coordinated private company responses, public police and private security, and owner communication.
(g) Roof Top Mounted Civilian Drone Miniature Airplane for crime tracking, evidencing, and apprehension, through centralized remote control launching and coordination of law enforcement personnel.
(h) Squad or Security Company Car Mounted Drone Miniature Airplane or Miniature Jet or Regular Helicopter with dual power system gasoline engine and electrical battery and generator for quiet running short term close up surveillance for purpose of business armed robbery and home burglary and invasion suspect apprehension, crime tracking, evidencing, and apprehension, through centralized and road patrol launching and coordination of law enforcement personnel.
(i) The addition of marine boat mounted communication, GPS, and camera, and the interconnection with cell phones, will allow for improved rescue efforts and communication in marine situations.
(j) The invention of home security system sensor triggered cellular phone alarm tone and instant video/audio transmission from the monitored home or business location and also 911 call transfer ability to law enforcement.
(k) The invention of the cellular phone and computer combination with detachable and/or fixed Motorized Telephoto Lens combination as shown in item 16 detail 1.
(l) This new system will allow individuals to monitor their own security systems instead of paying for monitoring. The owner may also elect for third party monitoring in the event that they are away from their cell in the event that the number of rings has expired without answering, a professional security system monitoring will answer, and the system owner may also elect to transfer the responsibility to any one of the cell phone users in group. By pushing a button for 911 a situation may be recorded and transferred to the police authorities for handling through their internet connection. Alarm sensors will sound on the phone indicating that a sensor has been tripped this will be followed by camera and sound from that same location in order for the owner to determine the situation involved.
(m) Remote controllable from police station or operated by deputy video/audio camera remote controlled pivoting with 100′ permanent vehicle mounted telescoping antenna and lethal/non-lethal force coordinated weapons remote controlled paint ball, bean bag, tear gas, long range tazer, 9 mm shorts and 45 cal. or rifle cartridge gun or a combination of two or more. It will include private security and business owner monitoring switchable to law enforcement control of lethal and non-lethal weapons.
(n) Remote control police operated camera and center fire semi-automatic firearm (9 mm to 45 Caliber). We also claim anything contained the drawings descriptions and specifications which constitutes an invention, including anything contained in the abstract.
(o) Remote camera weapon guidance system. The original concept of aiming, viewing, and firing, of an actual weapon by remote control including a target screen overlay of the actual live video.
(p) The requirement of criminal background checks for all cellular systems, particularly non-registered phones, including advanced audio/video and remote control systems. This is necessary due to criminals coordinating criminal activities using cellular communications.
(q) 911 caller cellular phone to dispatcher instant audio/video transmission send and caller location display screen in dispatcher office for emergency communications improvements.
(r) Police vehicle radio remote controlled dash mounted audio/video cam or telescoping vehicle mounted surveillance camera.
(s) The conversion of existing citizens band related police radio to more secure police recorded cellular transmissions.
